(19) United States
(12) Patent Application Publication
(10) Pub. No.: US 2025/0029180 A1
(43) Pub. Date: Jan. 23, 2025

(54) Intra-Day Momentum Method - A Scientific Approach to Trading

(71) Applicants: Todd R. Hudson, High Point, NC (US); Robert L Hudson, High Point, NC (US)

(72) Inventors: Todd R. Hudson, High Point, NC (US); Robert L Hudson, High Point, NC (US)

(21) Appl. No.: 18/775,412

(22) Filed: Jul. 17, 2024

Related U.S. Application Data
(60) Provisional application No. 63/527,201, filed on Jul. 17, 2023.

(51) Int. Cl. G06Q 40/04; G06Q 30/0202

(52) U.S. Cl. CPC G06Q 40/04; G06Q 30/0202

(57) ABSTRACT

The Intra-Day Momentum Method is a scientific approach to trading that addresses the flaws of traditional technical analysis techniques. Developed by Todd R. Hudson, this method utilizes historical data to identify price levels indicating sufficient directional market movement from the open, potentially leading to a close in the same direction. The method allows for defining trading patterns and validating trading tendencies based on these levels.

### CROSS REFERENCE TO RELATED APPLICATIONS

A provisional application has been filed Application No. 63/527,201.

### BACKGROUND OF THE INVENTION

After taking the job as an Equity Trader in June 2004, I would listen to the traders discuss why they wanted to trade certain stocks. They provided their interpretation of the traditional technical and fundamental analysis. I asked myself a simple question, after making some observations on my own. “Is what they thought they saw, actually what was happening?” After a few days of making observations, I decided that oftentimes, traditional technical analysis was playing tricks on people's eyes. Which in turn affected their thoughts as well as their beliefs.

Analysts often mention that a stock has tested a moving average. This is not always the case. Due to the nature of how the moving average is calculated, the fact is that it is typically not known before the close of the trading session. The most common calculation for a moving average is to use the close of the current trading session. Oftentimes when the price was at that level (the proposed moving average), the moving average was somewhere else. This is because during the trading session, the moving average is constantly moving. Most technical indicators' value is determined at the close of the time period to which the indicator is being applied to. Therefore, if you ask someone where the x-period moving average is, they won't be able to tell you. Because it isn't known until the time period has ended. This implies that the value of the indicator is usually known after a reasonable action can be taken. If an analyst states that a 20 day moving average has been tested, the moving average is based on the close of the day. That calculation is placed directly beneath that day's price data.

I also realized that traditional technical analysis techniques allowed the data to move the reference points around in real time. Knowing data points before they are reached would make the process more efficient.

The data in stock charting applications is often normalized by time. This is most prevalent intra-day. This approach allows the trader to change the time period in which the data is displayed. Therefore, a trader can change the way the data is presented. He can choose any time period that he would like. This is another issue with traditional analysis techniques: the user is allowed to manipulate the data. The user can manipulate the data by changing the timeframe that is being applied to the data.

It has been stated that ‘Fast Moves’ have a tendency to come from ‘False Moves.’ The best way to try to demonstrate this is to create a method whereby a ‘Fast Move’ can be identified.

A solution would require that the reference points be stabilized and constant. This makes the process more efficient and allows patterns to be defined and market tendencies to be validated. This process does not allow for the manipulation of the data.

Two articles were published by me (Todd R. Hudson) on TradingMarkets.com in May 2013. Both articles discussed the idea behind the invention as well as ways to implement the method with tools that traders were currently implementing.

### BRIEF SUMMARY OF THE INVENTION

The Intra-Day Momentum Method was developed to provide a solution to the flaws of traditional technical analysis techniques. This model uses historical data to determine price levels that indicate that the market has provided enough of a directional move from the open that it will likely close in the direction of the level reached. From these levels, trading patterns can be defined and trading tendencies can be validated.

### BRIEF DESCRIPTION OF THE DRAWINGS

In the following detailed section, the present application will be explained with reference to example embodiments shown in the drawings.

FIG. 1

This figure shows all levels both major and sub-levels. The levels are calculated using the table in FIG. 2.

FIG. 2

The formulas are used to calculate the levels presented in FIG. 1. The variable (x) is provided by the algorithm.

FIG. 3

This image shows the application of the model to the QQQ price data. It shows the ML1, ML2, and ML3 levels on the graph.

FIG. 4

This image shows the application of the model to the SPY price data. The MS1, MS2, and MS3 levels are labeled on the graph.

FIG. 5

This figure shows how the extended levels will be used to determine the historical location of the High/Low of the markets trading session.

FIG. 6

This figure shows how to use the ML1 Midpoint level. If the market reaches the ML1 and retraces back to the ML1 Midpoint level, using historical data we can determine what percentage of the time the market returned to the ML1 level and closed above it.

FIG. 7

This figure shows how to use the MS1 Midpoint level. If the market reaches the MS1 and retraces back to the MS1 Midpoint level, using historical data we can determine what percentage of the time the market returned to the MS1 level and closed below it.

FIG. 8

This figure shows a ‘Fast Move’ as the SPY reached the ML1 in the first 30 minutes of trading. Over the next hour and a half, the SPY reached the MS1 level, presenting an intra-day reversal pattern.

FIG. 9

This figure shows a ‘Fast Move’ as the SPY reached the MS1 in the first 30 minutes of trading. It then became an intra-day reversal after reaching the ML1.

### DETAILED DESCRIPTION OF THE INVENTION

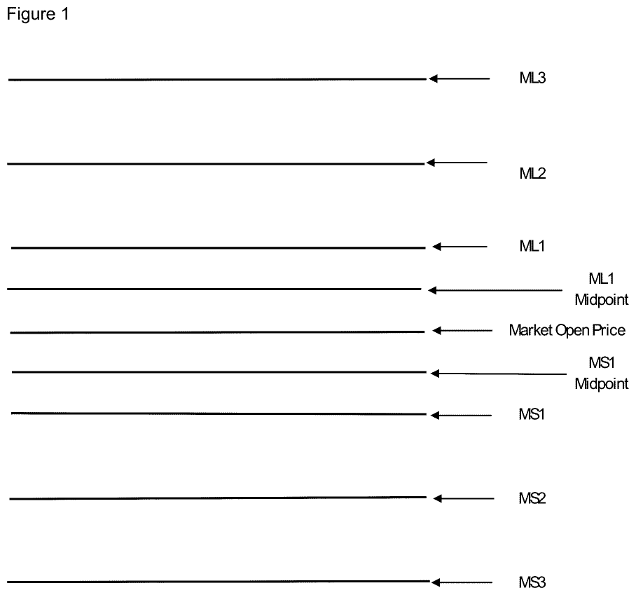

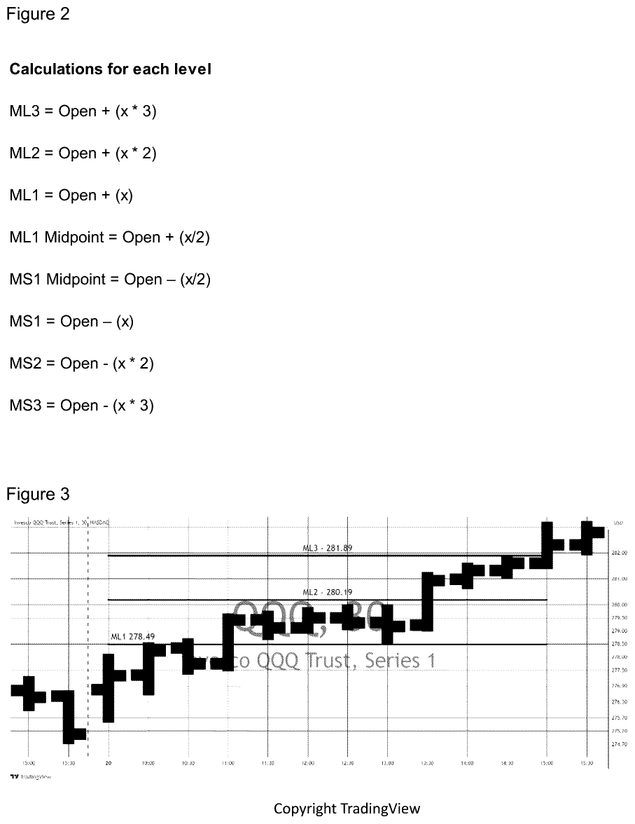

The Intra-Day Momentum Method model is a novel approach to analyze and trade the financial markets. The model uses proprietary algorithms to determine a distance (x) in price that is needed for the market to move up or down from the open to indicate that a market will likely close in that direction from the open. This was designed to determine short-term market direction with a reasonable degree of accuracy. The levels are calculated from the opening price of the market. The proprietary algorithm is used to determine the variable (x). To view the levels and how they are presented, refer to FIG. 1. The calculations used to determine the levels are presented in FIG. 2.

In FIG. 3, the application of the model is applied to the QQQ data. Once the QQQ has reached the ML1 level, the model can be used to determine what percentage of the time the market price closed at, above, or below the ML1 level. The model can also determine what percentage of the time the market closed above or below the open. The model can also be used to determine what percentage of the time the MS1 level was reached, after reaching the ML1. When both levels ML1/MS1 are met in the same trading session, an intra-day reversal pattern is created. The model can use historical analysis to determine how frequently this pattern repeats. It can also be used to give an indication on how to best approach the trading day after the intra-day pattern is present.

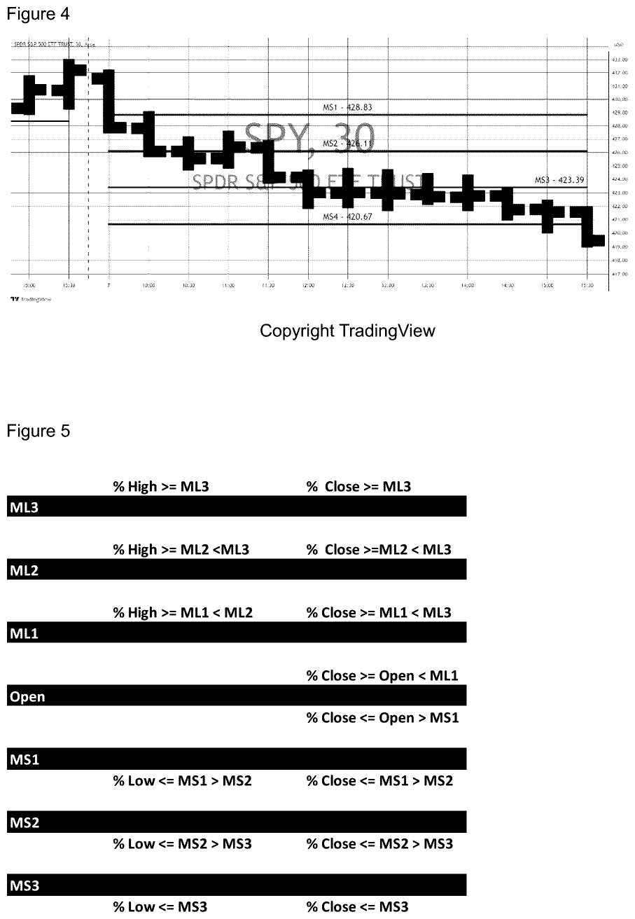

In FIG. 4, the model is applied to the SPY. Once the SPY has reached the MS1 level is, the model uses historical data to determine what percentage of the time the market closed at, above, or below the MS1 level. The model can also be used to determine what percentage of the time the market closes above or below the open, after reaching the MS1 level. It can also determine what percentage of the time the ML1 level was reached, after reaching the MS1. When both levels MS1/ML1 are reached in the same trading session, an intra-day reversal pattern is created. Identifying patterns helps a trader determine how to trade when and after the market has presented the pattern.

There are additional levels that are extended out in both directions, up and down from the open to a second and third level (ML2, ML3, MS2, MS3), this is shown in FIG. 1. Each major level is the same price distance from the previous level by the variable (x).

The extended levels are in place to capture a large portion of the trading range. This extension of the levels allows for additional patterns to be created and tested for validation. The trading range can also be determined by historical analysis of the data provided by the model when applied to financial markets. These levels can be used to determine what percentage of the time was the high of the day above the ML3 level. What percentage of the time was the low of the day below the MS3 level. The same calculations can be performed among the ML2/MS2 and ML1/MS1. A visual representation of the High/Low analysis is presented in FIG. 3.

There are sub-levels drawn at the midpoint from the open to the first level (ML1/MS1). These levels are referred to as ML1 Midpoint and MS1 Midpoint and are depicted in FIG. 1. The Midpoint levels are used to allow for the creation of additional patterns and to help validate market tendencies.

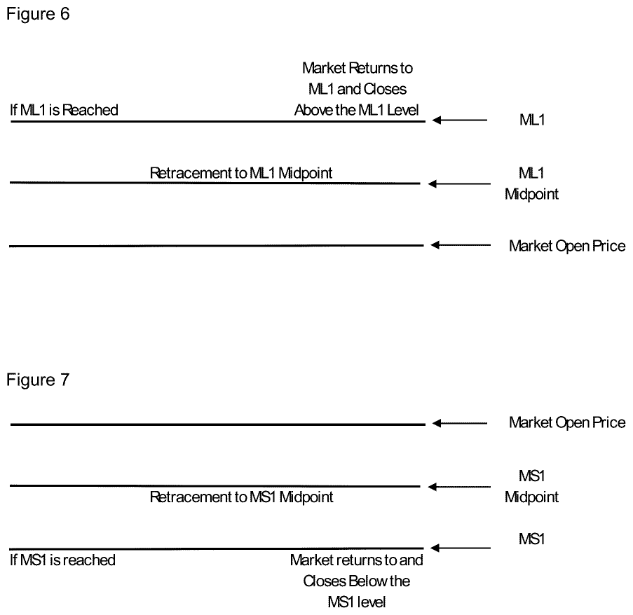

Once the ML1 level has been reached, the model can be used to determine what percentage of the time a retracement to the ML1 Midpoint would be followed by a move back above the ML1 level. The user will also want to determine if a retracement to the ML1 Midpoint would likely be followed by a move to either extended level, ML2 or ML3. This would allow the trader to determine if the retracement would be a valid entry or exit point for a ‘long’ trade. A visual representation of this conceptual use of the model is presented in FIG. 6.

Once the MS1 level has been reached, the model can be used to determine what percentage of the time a retracement to the MS1 Midpoint would be followed by a move back below the MS1 level. This would allow the trader to determine if the retracement would be a valid entry or exit point for a ‘short’ trade. The user will also likely want to determine if the retracement would likely be followed by a move to either extended level, MS2 or MS3. A visual representation of this conceptual use of the model is presented in FIG. 7.

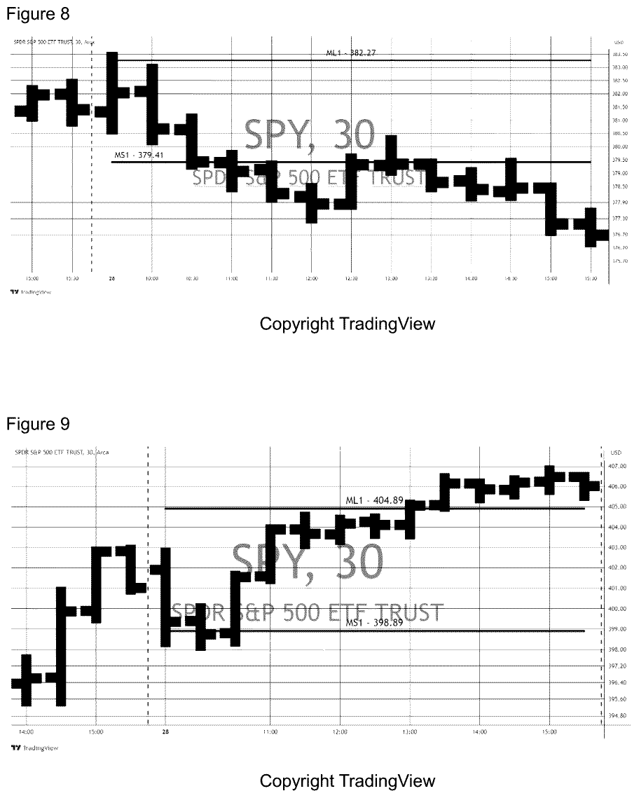

The levels can be used to help identify a ‘fast move.’ If the ML1 or MS1 is reached in the first 30 minutes of trading, it could be considered a ‘Fast Move.’ Identifying patterns, such as the ‘fast move’ help the trader to determine when to ‘trade’ in the direction of the fast more vs. when to fade a ‘fast move.’ In FIG. 8 you see the SPY reaches the ML1 level in the first 30 minutes of trading. Thuse creating a ‘Fast Move’ in the SPY. In the next 1.5 hours, the SPY reaches the MS1 level down. Creating an intra-day reversal pattern.

In FIG. 9, the Spy reaches the MS1 level down in the first 30 minutes of trading. It then climbs above the open and manages to get above the ML1 around 1 PM. Fast Moves that do not become intra-day reversals usually do not pullback all that much.

The levels presented by the model are designed to assist in determining short-term intra-day market direction. The levels are also designed to help identify ‘fast moves.’ The levels are also relevant to defining patterns. The levels generated by the model help in determining probabilistic outcomes using historical data when the model is applied to financial market data. The model helps a trader analyze market data based on patterns and assists the trader in validating trading tendencies.

The invention claimed is:

1. A novel approach for analyzing and trading markets consisting of predefined price levels:
to determine intra-day market direction with a reasonable degree of accuracy;
to help define market tendencies and patterns; and
to assist in validating market tendencies.
